(19) United States
(12) Patent Application Publication
(10) Pub. No.: US 2013/0185724 A1
(43) Pub. Date: Jul. 18, 2013

(54) NON-TRANSITORY RECORDING MEDIUM STORING INFORMATION PROCESSING PROGRAM, INFORMATION PROCESSING APPARATUS, INFORMATION PROCESSING SYSTEM, AND INFORMATION PROCESSING METHOD

(71) Applicant: Katsuyasu ANDO, Kyoto (JP)

(72) Inventor: Katsuyasu ANDO, Kyoto (JP)

(73) Assignee: Nintendo Co., Ltd., Kyoto (JP)

(21) Appl. No.: 13/437,337

(22) Filed: Apr. 2, 2012

(30) Foreign Application Priority Data
Jan. 16, 2012 (JP) 2012-006283

(51) Int. Cl. G06F 9/44

(52) U.S. Cl. 718/100

(57) ABSTRACT

An example information processing apparatus includes a duration acquisition unit to acquire a duration of a dormant state, and a processing unit to change a state of a predetermined program to be advantageous to a user when the duration of the dormant state is longer than a first time length. For example, the predetermined program is a game program and when the duration of the dormant state is longer than the first time length, the processing unit changes a parameter of the game program to be advantageous to the user.

This application is based upon and claims the benefit of priority of the prior Japanese Patent Application No. JP2012-006283, filed on Jan. 16, 2012, the entire contents of which are incorporated herein by reference.

### FIELD

The present disclosure relates to a recording medium recorded with an information processing program, an information processing apparatus, an information processing system, and an information processing method.

### BACKGROUND AND SUMMARY

Conventionally, there is technology of prompting a personal computer user or a game device user to take a break by guiding the line of sight of the user outside the screen.

When using a personal computer or a game device, desirably, the user takes proper breaks.

One mode of the present disclosure is a non-transitory recording medium storing an information processing program which causes an information processing apparatus to function as a duration acquisition unit to acquire a duration of a dormant state of the information processing apparatus, and a processing unit to change an execution state of a predetermined program to be advantageous to a user when the duration of the dormant state is longer than the first time length.

According to the information processing program stored in the recording medium as one mode of the present disclosure, the execution state of the predetermined program is changed to be advantageous to the user by causing the information processing apparatus to enter a dormant state longer than the first time length. It is thereby possible to motivate the user to cause the information processing apparatus to enter a dormant state continuously for a first time length or longer, and by extension to take a break.

With the information processing program stored in the recording medium as one mode of the present disclosure, the duration acquisition unit may acquire the duration of the dormant state of the information processing apparatus during the execution of the predetermined program. It is thereby possible to prompt the user to cause the information processing apparatus to enter a dormant state even during the execution of the predetermined program.

With the information processing program stored in the recording medium as one mode of the present disclosure, the information processing apparatus may execute at least one program during the execution of the predetermined program.

With the information processing program stored in the recording medium as one mode of the present disclosure, the information processing apparatus may function as the notification unit to implement notification to cause the information processing apparatus to enter a dormant state when the duration during which the predetermined program is executed is longer than a second time length. It is thereby possible to prompt the user to cause the information processing apparatus to enter a dormant state when the duration that the predetermined program is being executed is longer than the second time length.

With the information processing program stored in the recording medium as one mode of the present disclosure, the processing unit may change the execution state of the predetermined program to be disadvantageous to the user at least in a case of either a case where the information processing apparatus does not enter a dormant state after the notification by the notification unit, and a case where the duration of the dormant state is less than the first time length. It is thereby possible to strongly motivate the user to cause the information processing apparatus to enter a dormant state.

With the information processing program stored in the recording medium as one mode of the present disclosure, the information processing apparatus may function as the change notification unit to notify the user of change in the execution state of the predetermined program when the duration of the dormant state of the information processing apparatus is longer than the first time length. It is thereby possible to notify the user that the dormant state is now longer than the first time length, and that the execution state of the predetermined program has been changed to be advantageous to the user.

With the information processing program stored in the recording medium as one mode of the present disclosure, the predetermined program may be a game program, and the processing unit may change a parameter of the game program to be advantageous to the user when the duration of the dormant state is longer than the first time length. Since the parameter of the game program is changed to be advantageous to the user by causing the information processing apparatus to enter a dormant state for a length that is longer than the first time length, the user of the game program will be motivated to take a break.

With the information processing program stored in the recording medium as one mode of the present disclosure, the game program may be a game program to operate player characters, and the processing unit may change the execution state of the game program so as to increase the remaining number of the player characters when the duration of the dormant state is longer than the first time length. Consequently, since the user can play more games, the user will be more strongly motivated to cause the information processing apparatus to enter a dormant state.

With the information processing program stored in the recording medium as one mode of the present disclosure, the predetermined program may be a game program, and the processing unit may change the execution state of the game program so as to extend the playing time of the game program. Consequently, since the user can play the game for a longer time, the user will be more strongly motivated to cause the information processing apparatus to enter a dormant state.

With the information processing program stored in the recording medium as one mode of the present disclosure, the information processing apparatus may have a display device capable of stereoscopic display, and the information processing apparatus may be caused to additionally function as a display processing unit to instruct the display device to perform stereoscopic display. Consequently, the user operating the information processing apparatus having a display device capable of stereoscopic display is prompted to rest the eyes.

The present disclosure may also be a method, a system, an information processing apparatus or a program stored in a recording medium that is readable by a computer or other apparatuses and machines. Here, a computer-readable recording medium refers to a recording medium which accumulates information such as data and programs via electrical, magnetic, optical, mechanical, or chemical effects, and which can be read by a computer or the like.

### BRIEF DESCRIPTION OF THE DRAWINGS

FIG. 1 shows an example non-limiting the hardware configuration of the information processing apparatus;

FIG. 2 shows an example non-limiting the functional block of the information processing apparatus; and

FIG. 3 shows an example non-limiting the flowchart of the processing of the rest prompting program executed by the information processing apparatus.

### DETAILED DESCRIPTION OF NON-LIMITING EXAMPLE EMBODIMENTS

An embodiment of the present disclosure is now explained with reference to the drawings. The configuration of the following embodiment is merely an illustration, and the present disclosure is not limited to the configuration of the embodiments.

An object of the present disclosure is to provide a non-transitory recording medium storing an information processing program, an information processing apparatus, an information processing system, and an information processing method that will motivate a user to take a break.

In this embodiment, the information processing apparatus increases the motivation of a user to take a break by changing the execution state of a predetermined program to be advantageous to the user when the dormant state is continued for a predetermined time during the execution of the predetermined program. In this embodiment, the predetermined program is a game program where a player character defeats an enemy.

Moreover, in this embodiment, when the duration of the dormant state exceeds a predetermined time length, the information processing apparatus changes the parameter of the game to be advantageous to the user as the advantageous change for the user of the game program. For example, as the parameter of the game, the number of remaining player characters in the game is incremented by one.

In the present disclosure, the dormant state of the information processing apparatus 1 includes a power-saving state, a power shut-off state, and a state where the power of the display is turned off. The power-saving state is, for example, a state where the power of the respective devices mounted on the information processing apparatus is turned off, or a state where the respective devices are in a standby state. Moreover, in the power-saving state, processes and tasks including an OS, device driver and application programs designed to run even in a power-saving state, which are the bare minimum for the information processing apparatus 1 to be in a usable state, are running.

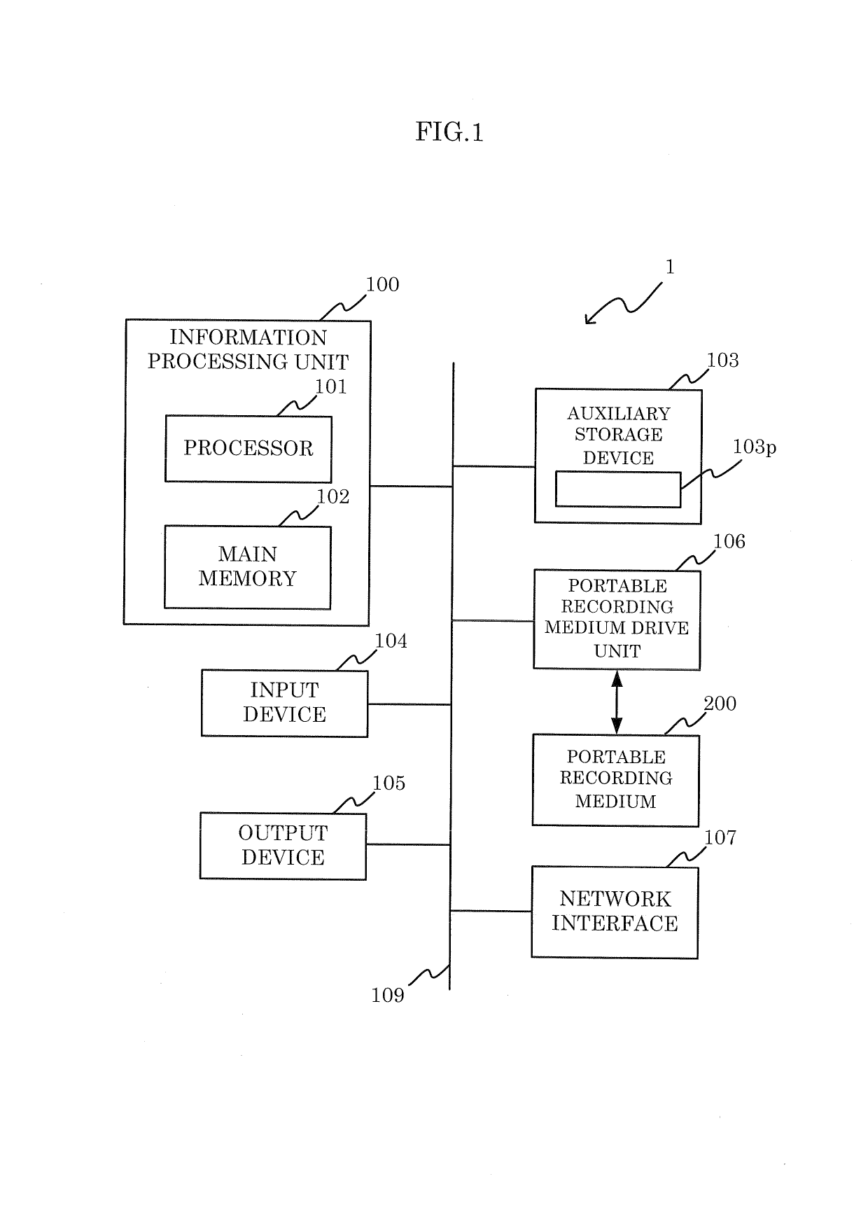

FIG. 1 is an example of the hardware configuration of the information processing apparatus 1. The information processing apparatus 1 is, for example, a personal computer, a smart phone, a portable telephone terminal, a tablet PC, a game device or the like. The information processing apparatus 1 includes an information processing unit 100, an auxiliary storage device 103, an input device 104, an output device 105, a portable recording medium drive unit 106, and a network interface 107, and these are mutually connected via a bus 109.

The input device 104 is, for example, a keyboard, a pointing device such as a mouse, a scanner, an operation button or the like. Moreover, the input device 104 may also include a voice input device such as a microphone. Data input from the input device 104 is output to the information processing unit 100.

The network interface 107 is an interface for inputting and outputting information to and from a network. The network interface 107 is connected to a wired network, and a wireless network. The network interface 107 is, for example, an NIC (Network Interface Card), a wireless LAN (Local Area Network) card or the like. Data and the like received by the network interface 107 are output to the information processing unit 100.

The auxiliary storage device 103 stores a plurality of programs, and data to be used by the information processing unit 100 upon executing the respective programs. The programs stored in the auxiliary storage device 103 include, for example, an operating system (OS) , a rest prompting program 103p, a game program, and other various programs. The auxiliary storage device 103 is, for example, an EPROM (Erasable Programmable ROM), or a Hard Disk Drive.

The portable recording medium drive unit 106 drives a portable recording medium 200 and inputs and outputs data to and from the portable recording medium 200 according to the signal from the information processing unit 100. The portable recording medium 200 is, for example, a recording medium such as a USB (Universal Serial Bus) flash memory, a CD (Compact Disc), or a DVD (Digital Versatile Disk).

The information processing unit 100 includes a processor 101 and a main memory 102. The main memory 102 is used for providing, to the processor 101, a storage area and a work area for loading the programs stored in the auxiliary storage device 103, or used as a buffer. The main memory 102 is, for example, a semiconductor memory such as a RAM (Random Access Memory).

The processor 101 is, for example, a CPU (Central Processing Unit), or a DSP (Digital Signal Processor). The processor 101 executes various types of processing as a result of loading into the main memory 102 and executing the OS, the rest prompting program 103p, the game program, and other various application programs retained in the auxiliary storage device 103.

The output device 105 outputs the processing results of the information processing unit 100. The output device 105 includes a display, and a display (display device) capable of stereoscopic display. Moreover, the output device 105 may also include a voice output device such as a speaker.

For example, with the information processing apparatus 1, the information processing unit 100 executes the rest prompting program 103p stored in the auxiliary storage device 103. When the execution time of the game program exceeds a predetermined time, the information processing apparatus 1 executes the rest prompting program 103p and prompts the user to cause the information processing apparatus to enter a dormant state. When the duration of the dormant state thereafter exceeds a predetermined time length, the information processing apparatus 1 increments the number of remaining player characters in the game by one.

The information processing apparatus 1 enters a dormant state, for example, based on a predetermined operation by a user such as the input of signals based on the user's operation of a mouse and a keyboard, or the pressing of the power button by the user. Moreover, if the information processing apparatus 1 is of a foldable shape, for example, the information processing apparatus 1 may enter a dormant state as a result of being folded in a state where the power is still on. Moreover, the information processing apparatus 1 may enter a dormant state based on a predetermined event. A predetermined event is, for example, the duration that the game program is being executed exceeding a predetermined time length.

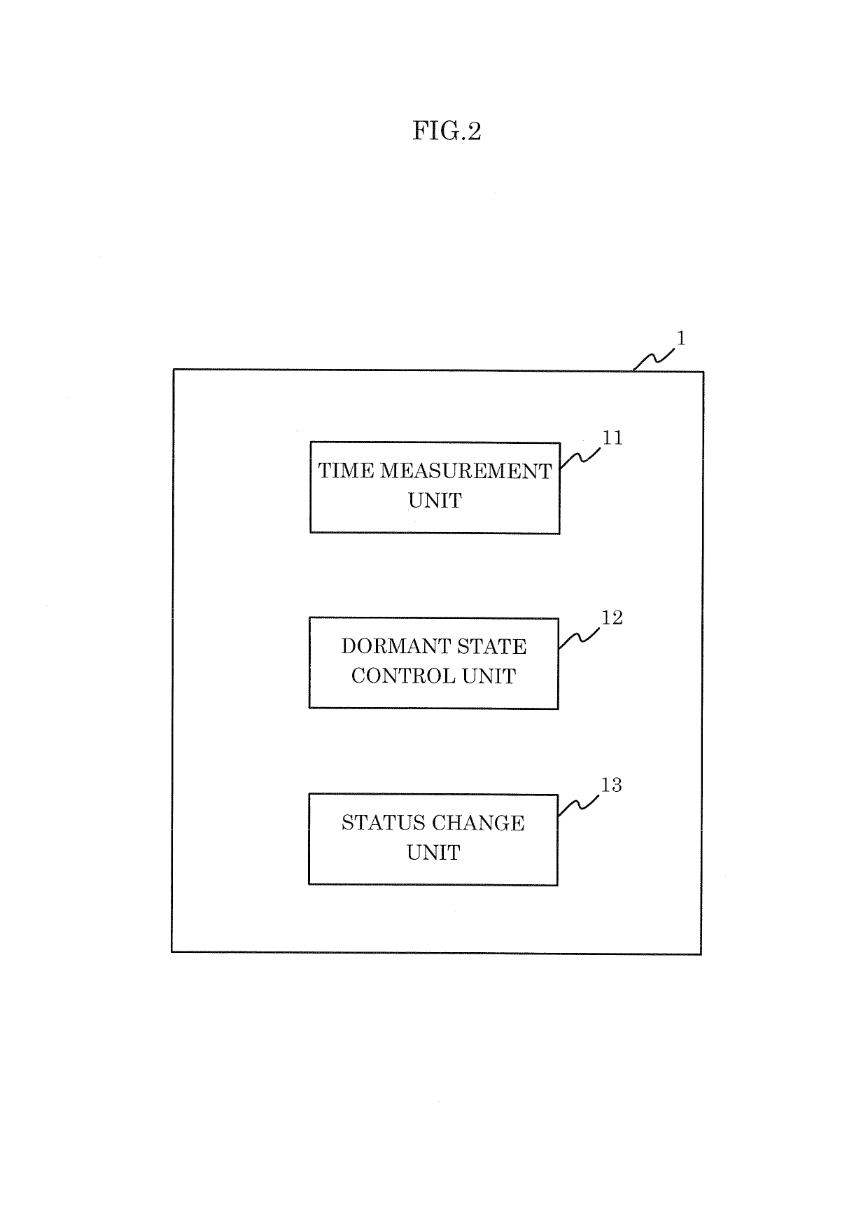

FIG. 2 is a diagram showing an example of the functional block of the information processing apparatus 1. The information processing apparatus 1 operates as a time measurement unit 11, a dormant state control unit 12, and a status change unit 13 based on the execution of the rest prompting program 103p by the information processing unit 100.

The time measurement unit 11 measures the elapsed time from the launch of the game program, and the duration of the dormant state of the information processing apparatus 1. The time measurement unit 11 measures the elapsed time from the launch of the game program, for example, according to one of the following methods.

(Measurement Method 1 of Elapsed Time from Program Launch)

The time measurement unit 11 activates a timer upon detecting the launch of the game program. For example, the time measurement unit 11 notifies the dormant state control unit 12 of the value of the timer, as the elapsed time from the program launch, at a predetermined cycle such as a cycle of 1 second to 10 seconds.

(Measurement Method 2 of Elapsed Time from Program Launch)

Upon detecting the launch of the game program, the time measurement unit 11 records the detected time, as the start time, in the buffer of the main memory 102. The time measurement unit 11 acquires the current time, for example, at a predetermined cycle such as a cycle of 1 second to 10 seconds, and notifies the dormant state control unit 12 of the difference between the current time and the start time, as the elapsed time from the program launch.

Subsequently, the time measurement unit 11 measures the duration of the dormant state of the information processing apparatus 1, for example, as follows. The time measurement unit 11 records the start time of the dormant state of the information processing apparatus 1 in the buffer of the main memory 102. When the time measurement unit 11 thereafter detects the return of the information processing apparatus 1 from the dormant state, it acquires that time as the end time. The time measurement unit 11 notifies the dormant state control unit 12 of the difference between the end time and the current time, as the duration of the dormant state. The time measurement unit 11 is an example of the “duration acquisition unit”.

Note that the time may be the start-up time of the information processing apparatus 1 based on a clock (not shown) provided to the information processing apparatus 1, the time that is generated by time software in the information processing apparatus 1, or the time acquired from the network.

The dormant state control unit 12 controls the processing pertaining to the start and end of the dormant state of the information processing apparatus 1. The dormant state control unit 12 retains a threshold 1 of the elapsed time from the program launch for determining the start of the dormant state, and a threshold 2 of the duration of the dormant state for determining the increase in the number of remaining player characters. The threshold 1 of the elapsed time from the program launch is, for example, 30 minutes to 1 hour. The threshold 1 of the elapsed time from the program launch is an example of the “second time length”. The threshold 2 of the duration of the dormant state is, for example, 1 hour to 2 hours. The threshold 2 of the duration of the dormant state is an example of the “first time length”.

The dormant state control unit 12 determines whether the elapsed time from the program launch notified at a predetermined cycle from the time measurement unit 11 is greater than or equal to the threshold 1. If the elapsed time from the program launch is greater than or equal to the threshold 1, the dormant state control unit 12 outputs a message to the output device 105 (for example, a display or a speaker) for prompting the user to enter a dormant state. When the dormant state control unit 12 thereafter detects an input from the user instructing that a dormant state be established, the information processing apparatus 1 is caused to enter a dormant state. Note that, when the elapsed time from the program launch becomes a predetermined time length that is greater than or equal to the threshold 1, the dormant state control unit 12 can also force the information processing apparatus 1 to enter a dormant state. The dormant state control unit 12 is an example of the “notification unit”.

The information processing apparatus returns from the dormant state, for example, based on the user's predetermined input to the information processing apparatus 1 such as the operation of a button or the switch-on of power. The dormant state control unit 12 acquires the duration of the dormant state from the time measurement unit 11, and determines whether the duration of the dormant state is greater than or equal to the threshold 2. If the duration of the dormant state is not less than the threshold 2, the dormant state control unit 12 sends a command to the status change unit 13. If the duration of the dormant state is less than the threshold 2, the dormant state control unit 12 does not send a command to the status change unit 13. Moreover, if the duration of the dormant state is less than the threshold 2, for example, the dormant state control unit 12 may announce a warning message from the output device 105 (for example, a display or a speaker).

The status change unit 13 changes the state of the game program to be advantageous to the player character according to the command from the dormant state control unit 12. For example, the status change unit 13 changes the state of the game program so that the user can play the game longer. In this embodiment, the status change unit 13 increments the remaining number of player characters in the game program by one. Specifically, the status change unit 13 increments the remaining number of player characters in the data of the game program stored in the main memory 102 or the auxiliary storage device 103 by one. The status change unit 13 is an example of the “processing unit”.

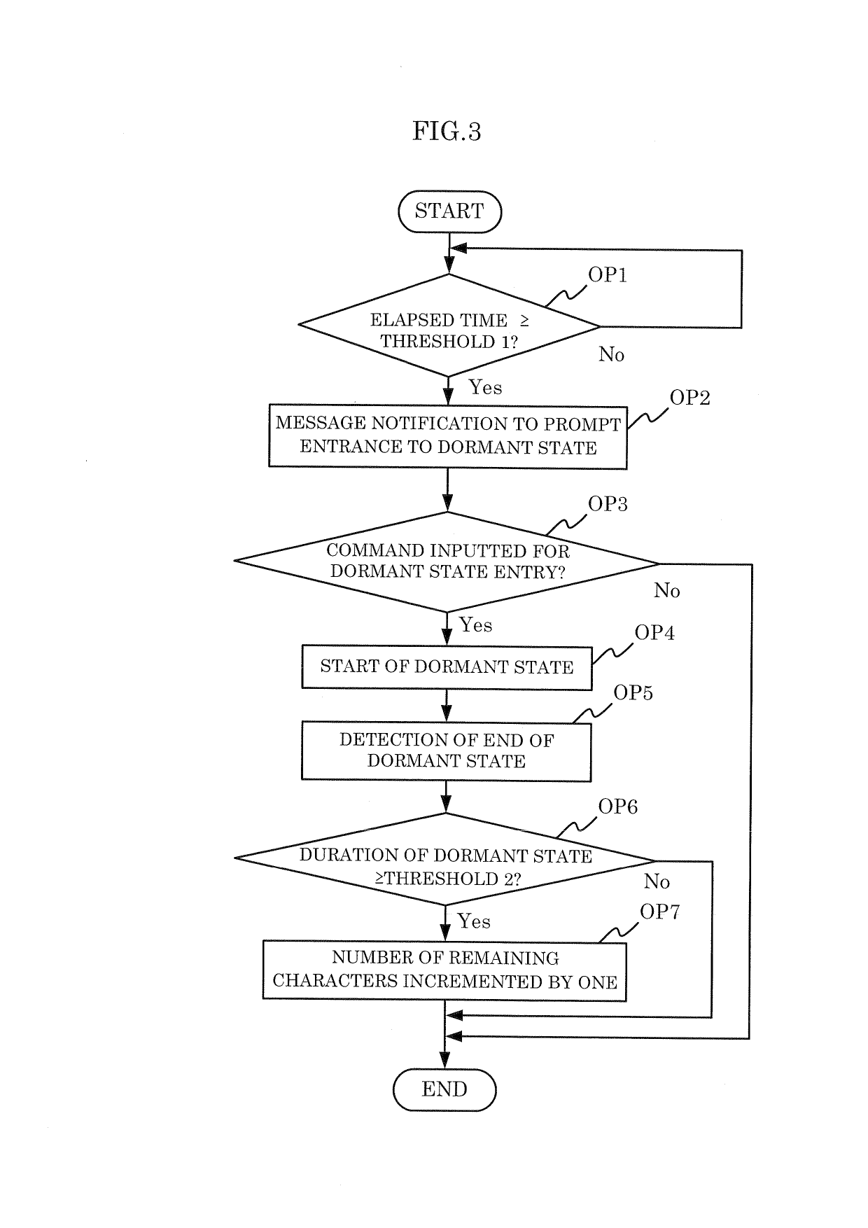

FIG. 3 is an example of the flowchart of the processing of the rest prompting program 103p executed by the information processing apparatus 1. The processing of the flowchart shown in FIG. 3 is started when the game program is started.

In OP1, the information processing unit 100 acquires the elapsed time from the program launch, and determines whether the elapsed time is greater than or equal to the threshold 1. If the elapsed time from the program launch is greater than or equal to the threshold 1 (OP1: Yes), the processing proceeds to OP2. If the elapsed time from the program launch is less than the threshold 1 (OP1: No), the processing of OP1 is repeated until the elapsed time is greater than or equal to the threshold 1. Acquisition of the elapsed time from the program launch is one processing of the time measurement unit 11. The determination of whether the elapsed time from the program launch is greater than or equal to the threshold 1 is one processing of the dormant state control unit 12.

In OP2, the information processing unit 100 notifies, from the output device 105, a message prompting the user to cause the information processing apparatus 1 to enter a dormant state. For example, the message may be displayed on a display. Moreover, for example, a voice message may be output from a speaker. The processing of OP2 is one processing of the dormant state control unit 12.

In OP3, the information processing unit 100 determines whether a command for entering a dormant state is input by the user. A command from the user for entering a dormant state is input, for example, from the input device 104 such as a an operation button, a keyboard, or a mouse. Moreover, if the information processing apparatus 1 is of a foldable shape, the information processing apparatus 1 detects the input of a command for entering a dormant state by detecting that the information processing apparatus 1 has been folded. If a command from the user for entering a dormant state is input (0P3: Yes), the processing proceeds to OP4. If a command from the user for entering a dormant state is not input, for example, even after the lapse of a predetermined time (0P3: No), the processing of the flowchart shown in FIG. 3 is ended. The processing of OP3 is one processing of the dormant state control unit 12.

In OP4, the information processing unit 100 causes the information processing apparatus 1 to enter a dormant state. For example, the information processing unit 100 causes the information processing apparatus 1 to enter a dormant state by causing the respective devices of the information processing apparatus 1 to enter a standby state. Moreover, in the foregoing case, the information processing unit 100 records the start time of the dormant state. The processing of causing the information processing apparatus 1 to enter a dormant state is one processing of the dormant state control unit 12. Moreover, the processing of recording the start time of the dormant state is one processing of the time measurement unit 11.

In OP5, the information processing unit 100 detects the end of the dormant state. The dormant state is ended, for example, based on the user's operation of an input device such as an operation button, a keyboard or a mouse, or a power button. The processing subsequently proceeds to OP6. The processing of OP5 is one processing of the dormant state control unit 12.

In OP6, the information processing unit 100 acquires the duration of the dormant state, and determines whether the duration of the dormant state is greater than or equal to the threshold 2. If the duration of the dormant state is greater than or equal to the threshold 2 (0P6: Yes), the processing proceeds to OP7. If the duration of the dormant state is less than the threshold 2 (0P6: No), the processing of the flowchart shown in FIG. 3 is ended. The acquisition of the duration of the dormant state is one processing of the time measurement unit 11. The determination of whether the duration of the dormant state is greater than or equal to the threshold 2 is one processing of the dormant state control unit 12.

In OP7, the information processing unit 100 increments the number of remaining player characters in the game program by one. The flowchart shown in FIG. 3 is thereafter ended. The processing of OP7 is one processing of the status change unit 13.

### Operation and Effect of Embodiments

The information processing apparatus 1 of this embodiment causes the information processing apparatus 1 to enter a dormant state when the elapsed time from the program launch is greater than or equal to the threshold 1, and increments the number of remaining player characters by one upon returning from the dormant state when the duration of the dormant state is greater than or equal to the threshold 2. The threshold 2 of the duration of the dormant state is roughly 1 hour to 2 hours, and is sufficient time for resting the eyes. Thus, according to the information processing apparatus 1 of this embodiment, when the user causes the information processing apparatus 1 to enter a dormant state continuously for a period that is greater than or equal to the threshold 2, the number of remaining player characters is incremented by one, and the user can play the game for a longer time. Thus, the user will be motivated to take a sufficiently long break for resting his/her eyes.

Note that this embodiment explained a case of incrementing the number of remaining player characters by one as the advantageous change to the user in the game program. Without limitation thereto, as an advantageous change to the user in the game program, for example, the remaining time can be extended, items can be granted, the performance of the player character in the game can be increased, game play in a hidden stage can be provided, and so on.

Moreover, in this embodiment, the rest prompting program 103p is launched when the game program is launched. However, without limitation thereto, the rest prompting program 103p may also be launched when the information processing apparatus 1 is launched, measure the elapsed time from the activation of the information processing apparatus 1, and send a message of prompting the transition to a dormant state when the measurement time becomes the threshold 1 or higher. Moreover, the rest prompting program 103p may also change other application programs, in addition to the game program, to be advantageous to the user when the duration of the dormant state is greater than or equal to the threshold 2.

### Modified Examples

The dormant state control unit 12 may also issue a command to the status change unit 13 for changing the state of the game program to be disadvantageous to the user if a command for entering a dormant state is not input from the user even when the elapsed time from the program launch is greater than or equal to the threshold 1 and/or if the duration of the dormant state is less than the threshold 2. As changes that are disadvantageous to the user in the game program, there are, for example, decrementing the number of remaining player characters by one, shortening the remaining time, lowering the level of the player character in the game, lowering the moving speed of the player character in the game, and so on.

As a result of the changing the state of the game program to be disadvantageous to the user if a command for entering a dormant state is not input from the user even when the elapsed time from the program launch is greater than or equal to the threshold 1 and/or if the duration of the dormant state is less than the threshold 2, it is possible to strongly motivate the user to cause the information processing apparatus 1 to enter a dormant state, and by extension to take a break.

Moreover, for example, if the information processing apparatus 1 becomes a power-saving state when it enters a dormant state, the time measurement unit 11 may adopt the same method as the measurement method 1 or 2 of the elapsed time from the program launch as the method of measuring the duration of the dormant state. When the dormant state is a power-saving state and the time measurement unit 11 acquires the duration of the dormant state based on the same method as the measurement method 1 or 2 of the elapsed time from the program launch, the dormant state control unit 12 may also notify the output device 105 of the status change (or end of the rest time) of the game program (for example, a display or a speaker) when the foregoing duration becomes greater than or equal to the threshold 2. The dormant state control unit 12 is an example of the “change notification unit”.

### (Others)

Moreover, in the foregoing embodiment, the processing of the foregoing flowchart is performed as a result of the information processing unit 31 of the game device 1 executing predetermined programs, but a part or all of the foregoing processing may also be performed by a dedicated circuit of the game device 1.

Moreover, in addition to the rest prompting program 103p being provided to the information processing apparatus 1 through an external storage medium such as the portable recording medium 200, it may also be provided to the information processing apparatus 1 through a wired or wireless communication line. As the information storage medium for storing the rest prompting program 103p, in addition to a nonvolatile memory, a CD-ROM, a DVD or other similar optical disk-shaped storage mediums, a flexible disk, a hard disk, a magneto optical disk, a magnetic tape and the like can also be used. Moreover, as the information storage medium for storing the rest prompting program 103p, a volatile memory for temporarily storing the foregoing program may also be used. This kind of external storage medium is a recording medium that can be read by a computer or the like. For example, the various functions explained above can be provided by causing a computer or the like to read and execute the programs stored in the recording medium.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims. Moreover, it is understood that a person skilled in the art can implement an equivalent scope as the present disclosure based on the descriptions of the present disclosure and common technical knowledge from the description of the specific embodiment of the present disclosure. Moreover, the terms used in this specification are understood to have the meaning that is generally used in the relevant field unless a specific reference is made regarding such term. Accordingly, unless separately defined herein, all specialized terms and technical terms used in this specification shall have the same meaning as the terms which are generally understood by a person skilled in the art of the field to which the present disclosure belongs. If there is any inconsistency in the meaning of the terms, this specification (including the definitions) shall prevail.

What is claimed is:

1. A non-transitory recording medium storing an information processing program causing an information processing apparatus to function as:
a duration acquisition unit to acquire a duration of a dormant state of the information processing apparatus; and
a processing unit to change an execution state of a predetermined program to be advantageous to a user when the duration of the dormant state is longer than a first time length.

2. The non-transitory recording medium storing an information processing program according to claim 1, wherein the duration acquisition unit acquires the duration of the dormant state of the information processing apparatus during execution of the predetermined program.

3. The non-transitory recording medium storing an information processing program according to claim 2, wherein the information processing apparatus executes at least one program during the execution of the predetermined program.

4. The non-transitory recording medium storing an information processing program according to claim 2, which causes the information processing apparatus to additionally function as an notification unit to implement notification to cause the information processing apparatus to enter a dormant state when the duration during which the predetermined program is executed is longer than a second time length.

5. The non-transitory recording medium storing an information processing program according to claim 4, wherein the processing unit changes the execution state of the predetermined program to be disadvantageous to the user at least in a case of either a case where the information processing apparatus does not enter a dormant state after the notification by the notification unit, and a case where the duration of the dormant state is less than the first time length.

6. The non-transitory recording medium storing an information processing program according to claim 1, which causes the information processing apparatus to additionally function as a change notification unit to notify the user of change in the execution state of the predetermined program when the duration of the dormant state of the information processing apparatus is longer than the first time length.

7. The non-transitory recording medium storing an information processing program according to claim 1, wherein
the predetermined program is a game program, and
the processing unit changes a parameter of the game program to be advantageous to the user when the duration of the dormant state is longer than the first time length.

8. The non-transitory recording medium storing an information processing program according to claim 7, wherein
the game program is a game program to operate player characters, and
the processing unit changes the execution state of the game program so as to increase the remaining number of the player characters when the duration of the dormant state is longer than the first time length.

9. The non-transitory recording medium storing an information processing program according to claim 7, wherein the processing unit changes the execution state of the game program so as to extend the playing time of the game program.

10. The non-transitory recording medium storing an information processing program according to claim 1, wherein
the information processing apparatus has a display device capable of stereoscopic display, and
the information processing apparatus is caused to additionally function as a display processing unit to instruct the display device to perform stereoscopic display.

11. An information processing apparatus, comprising:
a duration acquisition unit to acquire a duration of a dormant state of an information processing apparatus; and
a processing unit to change an execution state of a predetermined program to be advantageous to a user when the duration of the dormant state is longer than a first time length.

12. An information processing system, comprising:
a duration acquisition unit to acquire a duration of a dormant state of an information processing apparatus; and
a processing unit to change an execution state of a predetermined program to be advantageous to a user when the duration of the dormant state is longer than a first time length.

13. An information processing method executed by an information processing apparatus, comprising:
acquiring a duration of a dormant state; and
changing an execution state of a predetermined program to be advantageous to a user when the duration of the dormant state is longer than a first time length.
